(19) United States
(12) Patent Application Publication
(10) Pub. No.: US 2012/0223818 A1
(43) Pub. Date: Sep. 6, 2012

(54) DATA RANDOM SELECTION DEVICE

(75) Inventors: Shyh-Rong LUO, HSINCHU CITY (TW); Mu-Feng KU, HSINCHU CITY (TW)

(73) Assignee: SINO MATRIX TECHNOLOGY, INC., HSINCHU CITY (TW)

(21) Appl. No.: 13/039,331

(22) Filed: Mar. 3, 2011

(51) Int. Cl. H04Q 5/22

(52) U.S. Cl. 340/10.42

(57) ABSTRACT

A data random selection device includes a data generation module and a data reading module. The data generation module includes a RFID tag and indication units. The RFID tag stores and sends an identification code, and one of the indication units is randomly driven to generate an indication signal when the RFID tag sends the identification code. The data reading module includes a wireless radio frequency reader and an output unit. The wireless radio frequency reader receives the identification code and reads the indication value corresponding to the randomly driven indication unit. The output unit outputs identification code and the indication value.

### BACKGROUND

1. Technical Field

The present disclosure relates to an electronic device. More particularly, the present disclosure relates to a data random selection device.

2. Description of Related Art

In conventional board games or gambling games appearing in the markets, such as MONOPOLY, one-armed bandits, Russian roulette, etc., data random selection tools are usually necessary in order to randomly generate one out of multiple values. For example in MONOPOLY game, the position of player is determined by the roll of dice, and the number of upwardly shown face of the dice represents forward moves such that each number of six faces of the dice represents one possible result. On the other hand, in Russian roulette game, the results are respectively corresponding to numbers by spinning the roulette wheel where the ball drops, such that one out of multiple numbers can be randomly selected.

However, the selected choices appeared by these random selection devices are fixed. If the amount of the choices and probability of each choice are to be changed, a different hardware has to be used. For example, if one out of five items is to be selected, the dice cannot support that operation because it is only capable of showing one out of six results. Moreover, many random selection devices (e.g. Russian roulette wheel) are bulky and heavy and also are inconvenient to carry and expensive.

For the foregoing reasons, there is a need to provide a convenient and portable random selection device with programmable and variable selections.

### SUMMARY

The present disclosure is to provide a data random selection device to solve the problems mentioned above.

An aspect of the present invention provides a data random selection device comprising a data generation module and a data reading module. The data generation module comprises a radio frequency identification (RFID) tag and a plurality of indication units, in which the RFID tag is configured for storing and sending an identification code, the indication units are electrically coupled to the RFID tag and separately corresponding to indication values, and one of the indication units is randomly driven to generate an indication signal when the RFID tag sends the identification code. The data reading module is disposed with respect to the data generation module and comprises a wireless radio frequency reader and an output unit. The wireless radio frequency reader is configured for receiving the identification code and reading the indication value corresponding to the randomly driven indication unit. The output unit is electrically coupled to the wireless radio frequency reader, for outputting at least the indication value corresponding to the randomly driven indication unit.

In accordance with one embodiment of the present invention, the data generation module further comprises an operation mode configuration unit for selectively deactivating at least one of the indication units, such that one of the rest of the indication units is randomly driven to generate another indication signal.

In accordance with another embodiment of the present invention, the data generation module further comprises a random control unit electrically coupled to the indication units, for randomly driving one of the indication units.

In accordance with yet another embodiment of the present invention, the data generation module further comprises a reset unit electrically coupled to the RFID tag, for driving the RFID tag to re-send the identification code and triggering the random control unit to randomly drive one of the indication units again to generate another indication signal.

In accordance with still another embodiment of the present invention, the output unit is a display screen, a speaker or the combination thereof, and the indication units comprise a plurality of indicator lights.

Another aspect of the present invention is to provide a data random selection device comprising a plurality of data generation modules and a data reading module.

Each of the data generation modules comprises a radio frequency identification (RFID) tag and a plurality of indication units. The RFID tag is configured for storing and sending an identification code. The indication units is electrically coupled to the RFID tag and separately corresponding to indication values, and one of the indication units is randomly driven to generate an indication signal when the RFID tag sends the identification code. The data reading module is disposed with respect to the data generation modules and comprises a wireless radio frequency reader and an output unit. The wireless radio frequency reader is configured for receiving the identification codes sent by the RFID tags in the data generation modules and reading the indication values corresponding to the randomly driven indication units in the data generation modules. The output unit is electrically coupled to the wireless radio frequency reader, for outputting at least the indication values corresponding to the randomly driven indication units in the data generation modules.

In accordance with one embodiment of the present invention, in each of the data generation modules the identification code and the indication value corresponding to the randomly driven indication unit are combined to be a group of identification data, the identification data from the data generation modules are combined to be an operation command, and the output unit outputs the operation command.

In accordance with another embodiment of the present invention, each of the data generation modules further comprises an operation mode configuration unit for selectively deactivating at least one of the indication units, such that one of the rest of the indication units is randomly driven to generate another indication signal.

In accordance with yet another embodiment of the present invention, each of the data generation modules further comprises a random control unit electrically coupled to the indication units, for randomly driving one of the indication units.

In accordance with still another embodiment of the present invention, each of the data generation modules further comprises a reset unit electrically coupled to the RFID tag, for driving the RFID tag to re-send the identification code and triggering the random control unit to randomly drive one of the indication units again to generate another indication signal.

In accordance with still yet another embodiment of the present invention, the output unit is a display screen, a speaker or the combination thereof, and the indication units comprise a plurality of indicator lights.

For the foregoing embodiments, the random selection device of the present invention is convenient and portable and also capable of being operated under multiple selection modes, providing more flexibility.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference to the accompanying drawings as follows:

FIG. 1 is a diagram of the data random selection device according to one embodiment of the present invention;

FIG. 2 is a block diagram of internal circuits of the passive data generation module according to one embodiment of the present invention;

FIG. 3 is a block diagram of internal circuits of the active data generation module according to one embodiment of the present invention; and

FIG. 4 is a diagram of the data random selection device according to another embodiment of the present invention.

### DESCRIPTION OF THE EMBODIMENTS

In the following description, several specific details are presented to provide a thorough understanding of the embodiments of the present invention. One skilled in the relevant art will recognize, however, that the present invention can be practiced without one or more of the specific details, or in combination with or with other components, etc. In other instances, well-known implementations or operations are not shown or described in detail to avoid obscuring aspects of various embodiments of the present invention.

The terms used in this specification generally have their ordinary meanings in the art and in the specific context where each term is used. The use of examples anywhere in this specification, including examples of any terms discussed herein, is illustrative only, and in no way limits the scope and meaning of the invention or of any exemplified term. Likewise, the present invention is not limited to various embodiments given in this specification.

As used herein, the terms “comprising,” “including,” “having,” “containing,” “involving,” and the like are to be understood to be open-ended, i.e., to mean including but not limited to.

Reference throughout the specification to “one embodiment” or “an embodiment” means that a particular feature, structure, implementation, or characteristic described in connection with the embodiment is included in at least one embodiment of the present invention. Thus, uses of the phrases “in one embodiment” or “in an embodiment” in various places throughout the specification are not necessarily all referring to the same embodiment. Furthermore, the particular features, structures, implementation, or characteristics may be combined in any suitable manner in one or more embodiments.

The steps are not recited in the sequence in which the steps are performed. That is, unless the sequence of the steps is expressly indicated, the sequence of the steps is interchangeable, and all or part of the steps may be simultaneously, partially simultaneously, or sequentially performed.

The embodiments of the present invention provide a data random selection device which at least includes a data generation module and a data reading module. The data generation module comprises a radio frequency identification (RFID) tag and a plurality of indication units. The indication units separately represent selection items supported by the data random selection device, each selection item corresponds to one indication value, and thus each indication unit corresponds to one indication value. In operation, after circuits in the RFID tag operate, one of the selection items is randomly selected, and the indication unit corresponding to the selected item is activated (for example, when the indication unit is implemented by an LED indicator light, the LED indicator light corresponding to the selected item is lighted up), and the indication units corresponding to the rest of the selection items being unselected are not activated. In addition, the RFID tag stores an identification code, and the identification code is combined with the indication value corresponding to the selected item to be a group of identification data, and then the group of identification data is transmitted to the data reading module.

The data reading module at least includes a wireless radio frequency reader and an output unit. The wireless radio frequency reader is configured for receiving the identification data, and the identification data is then outputted by the output unit. If the output unit is a display screen, the identification data are shown on the display screen; if the output unit is a speaker, the identification data are sent out in the form of sound.

In the embodiments of the present invention, the data generation module further includes a reset unit. After the reset unit is triggered, the identification data are erased and the data generation module sends preset identification data to the data reading module so that the preset identification data are outputted by the output unit, in which the preset identification data may include only the identification code. In the meanwhile, the data generation module starts a new round of operation, so as to randomly select one out of the selection items. Furthermore, the data generation module in the embodiment of the present invention also includes an operation mode configuration unit capable of selectively controlling the amount of selection items to be selected.

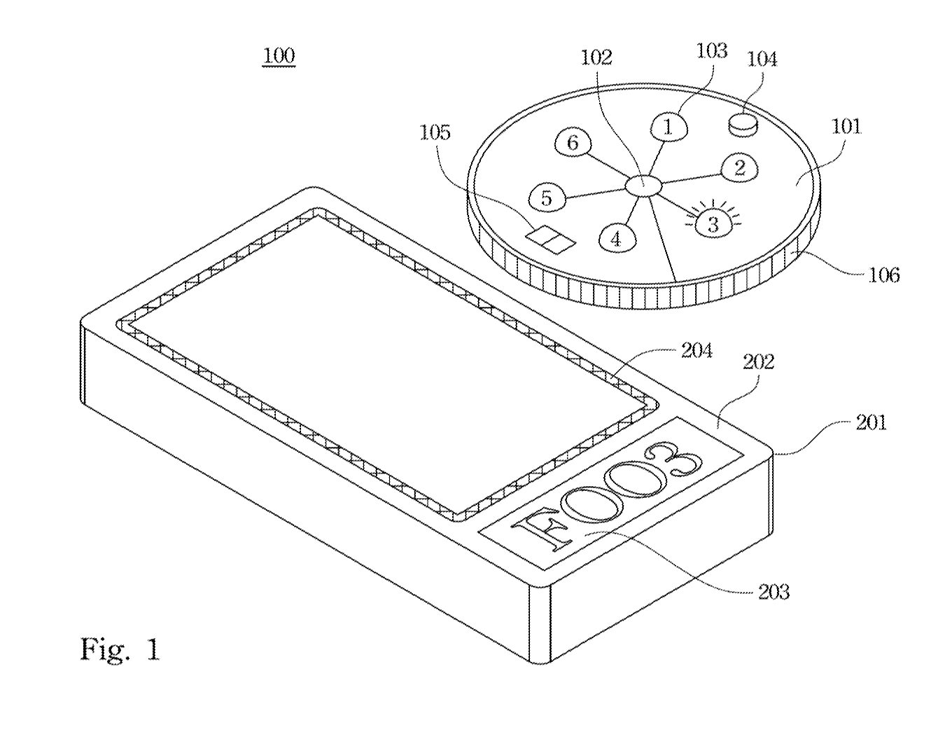

FIG. 1 is a diagram of the data random selection device according to one embodiment of the present invention. The data random selection device 100 includes a data generation module 101 and a data reading module 201. When the data generation module 101 approaches the data reading module 201 within a predetermined distance (e.g. a sensing distance necessary for a conventional wireless radio frequency operation), the data generation module 101 generates power supply due to the sense operation and starts to work, for generating a group of randomly selected data and transmitting the randomly selected data to the data reading module 201 to be outputted or displayed.

The data generation module 101 includes a radio frequency identification (RFID) tag 102, six LED indicator lights 103 (i.e. indication units, numbered from 1 to 6), a reset button 104, an antenna 106 and an operation mode configuration interface 105. It should be noticed that the amount of the LED indicator lights 103 are merely exemplary and not limited. The LED indicator lights 103, the reset button 104, the operation mode configuration interface 105 and the antenna 106 are all electrically coupled to the RFID tag 102. The RFID tag 102 is configured for storing and sending an identification code. The LED indicator lights 103 correspond to indication values, respectively, and one of the LED indicator lights 103 is randomly driven to be lighted up so as to generate an indication signal when the RFID tag 102 sends the identification code. Under a preset mode in the present embodiment, the data generation module 101 operates with six selection items (1 to 6) which correspond to the LED indicator lights 103 numbered from 1 to 6, respectively. The data reading module 201 includes a wireless radio frequency reader 202, an antenna 204 and a display screen 203, in which the wireless radio frequency reader 202 is electrically coupled to the display screen 203. The wireless radio frequency reader 202 is configured for receiving the identification code and reading the indication value corresponding to the randomly driven LED indicator light 103. The display screen 203 is configured for outputting the indication value corresponding to the randomly driven LED indicator light 103.

In operation, the wireless radio frequency reader 202 first sends an RF signal through the antenna 204. After that, the RFID tag 102 receives the RF signal through the antenna 106, and the LED indicator lights 103 numbered from 1 to 6 are randomly lighted up within a predetermined duration. After the predetermined duration, only the LED indicator light 103 corresponding to the selected item is driven to be lighted up, and the rest of the LED indicator lights 103 are turned off. For example, if the data generation module 101 generates the indication value corresponding to the selection item “3”, only the LED indicator light 103 numbered 3 is driven to be lighted up in the end. On the other hand, the RFID tag 102 stores the identification code, in which the identification code and the indication value corresponding to the selected item are sent to the data reading module 201. The wireless radio frequency reader 202 receives the identification code and the indication value corresponding to the selected item, and then the identification code and the indication value corresponding to the selected item are displayed on the display screen 203. The displayed data corresponding to the identification code can be characters, such as “F”, but not limited thereto. As shown in FIG. 1, the indication value corresponding to the selected item includes a number “3”, and the displayed data corresponding to the identification includes a character “F”, so the display screen 203 displays the result “F003”.

Moreover, the reset button 104 is configured for driving the RFID tag 102 to re-send the identification code and triggering the data generation module 101 to randomly drive one of the LED indicator lights 103 again to generate another indication signal. After the reset button 104 is pushed, the data generation module 101 sends a group of preset identification data to replace the data shown on the display screen 203 in a previous round of operation. For example, if the preset identification data include the result “F000”, the result “F003” originally displayed on the display screen 203 will be erased and the display screen 203 will show the result “F000”. Meanwhile, the data generation module 101 starts a new round of operation; that is, the LED indicator lights 103 are randomly lighted up within another predetermined duration, and the data generation module 101 generates the indication value corresponding to a new selected item. After the predetermined duration, only the LED indicator light 103 corresponding to the new selected item is driven to be lighted up, and the indication value corresponding to the new selected item, together with the identification code, are transmitted to the data reading module 201 and displayed on the display screen 203.

The operation mode configuration interface 105 is configured for setting the amount of selectable items and for selectively deactivating at least one of the LED indicator lights 103, such that one of the rest of the LED indicator lights 103 is randomly driven to generate another indication signal. As illustrated in FIG. 1, in the present embodiment, a preset amount of the selection items is six, thus the result of randomly selecting one out of six is generated after the data random generation device is operated, which is equivalent to a dice with six faces of numbers. The operation mode configuration interface 105 can set the amount of selectable items to be others; for example, it can set the amount of selectable items to be four to imitate a dice with four faces of numbers, or it can set the amount of selectable items to be two to imitate a coin. When the amount of selectable items is set, the corresponding amount of the LED indicator lights 103 have to be selectively deactivated; for example, when the amount of selectable items is set to be four, two of the six LED indicator lights 103 have to be deactivated such that, when the operation of selecting one out of four is performed, only the rest four activated LED indicator lights 103 are possibly driven to be lighted up; and so on.

In other words, if the amount of the selectable items is N, the operation mode configuration interface 105 is configured for selectively deactivating M of the N LED indicator lights 103, such that the result is to randomly select one out of the (N−M) items, where N is a positive integer larger than 1, and M is 0 or a positive integer smaller than (N−1). In practice, the operation mode configuration interface 105 may include at least one button but not limited thereto.

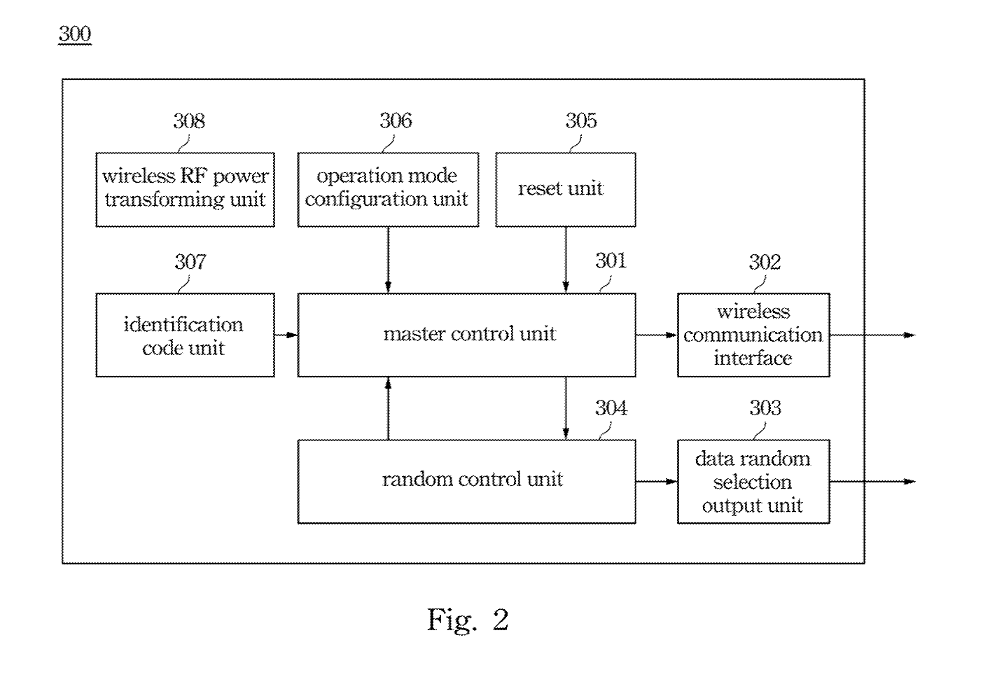

The data generation module 101 can be active or passive. FIG. 2 is a block diagram of internal circuits of the passive data generation module according to one embodiment of the present invention. The passive data generation module 300 includes a master control unit 301, a wireless communication interface 302, a data random selection output unit 303, a random control unit 304, a reset unit 305, an operation mode configuration unit 306, an identification code unit 307 and a wireless radio frequency (RF) power transforming unit 308. The main controlling mechanism which includes the master control unit 301, the data random selection output unit 303, the random control unit 304 and the identification code unit 307 can be integrated into the RFID tag 102 and implemented by a single chip.

Refer to FIG. 1 and FIG. 2 at the same time. The wireless RF power transforming unit 308 receives the RF signal from the wireless radio frequency reader 202 to generate sensing power supplied for the passive data generation module 300. The identification code unit 307 stores the identification code mentioned above. The master control unit 301 receives the identification code from the identification code unit 307 and controls the random control unit 304 to randomly generate the indication values corresponding to the selection items, so as to select one out of the six selectable items, and the random control unit 304 transmits the indication value corresponding to the selected item to the master control unit 301 and the data random selection output unit 303.

The master control unit 301 receives the indication values from the random control unit 304 and the identification code from the identification code unit 307. The master control unit 301 combines the indication values with the identification code to be a group of identification data, and transmits the group of identification data to the wireless communication interface 302. The wireless communication interface 302 outputs the group of identification data to the wireless radio frequency reader 202 by using the manner of wireless RF skill.

The data random selection output unit 303 is electrically coupled to the foregoing six LED indicator lights 103 and outputs the indication value corresponding to the selection result to the six LED indicator lights 103, such that one of the six LED indicator lights 103 generates one indication signal responsive to the indication value corresponding to, the selection result.

In practice, the reset unit 305 may be electrically coupled to the reset is button 104 shown in FIG. 1 or include the reset button 104, for generating a reset signal when the reset button 104 is pushed. Moreover, the operation mode configuration unit 306 may be electrically coupled to the operation mode configuration interface 105 shown in FIG. 1 or include the operation mode configuration interface 105, for generating an operation mode configuration signal.

When the reset button 104 is pushed, the reset unit 305 transmits the reset signal to the master control unit 301. The master control unit 301 clears the present identification data and transmits a group of preset identification data to the wireless communication interface 302, and the wireless communication interface 302 transmits the group of preset identification data to the wireless radio frequency reader 202, in which the preset identification data may include only the identification code mentioned above.

When a user sets the operation mode through the operation mode configuration interface 105, the operation mode configuration unit 306 transmits the operation mode configuration, signal to the master control unit 301, such that the master control unit 301 transmits another control signal to the random control unit 304 in order to set the random control unit 304 generating the indication values corresponding to the amount of the selection items, according to the operation mode, and deactivates the corresponding LED indicator lights 103 via the data random selection output unit 303 so as to set the amount of the selectable items. For example, if the user would like to manipulate the data random selection device 100 under a one-out-of-two mode (which imitates a coin), the amount of the selection items have to be set to two by the operation mode configuration interface 105 and the operation mode configuration unit 306. At the moment, the master control unit 301 transmits the control signal to request the random control unit 304 to change the amount of selectable items from six to two, and the random control unit 304 drives through the data random selection output unit 303 to deactivate four of the six LED indicator lights 103.

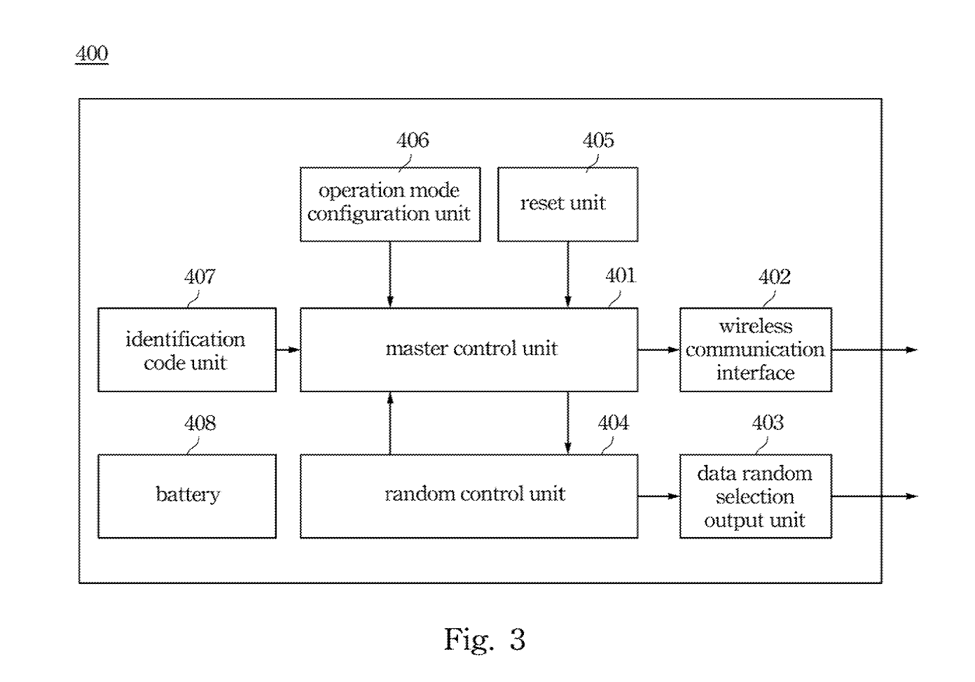

FIG. 3 is a block diagram of internal circuits of the active data generation module according to one embodiment of the present invention. The active data generation module 400 includes a battery 408, a master control unit 401, a wireless communication interface 402, a data random selection output unit 403, a random control unit 404, a reset unit 405, an operation mode configuration unit 406 and an identification code unit 407. The main controlling mechanism which includes the master control unit 401, the data random selection output unit 403, the random control unit 404 and the identification code unit 407 can be integrated into the RFID tag 102 and implemented by a single chip. The battery 408 may be externally connected with or embedded in the active data generation module 400. Compared to the data generation module 300, the active data generation module 400 in the present embodiment is mainly powered and supplied actively by the battery 408. Functions and cooperation of the other units are similar to those shown in FIG. 2, so the details are omitted.

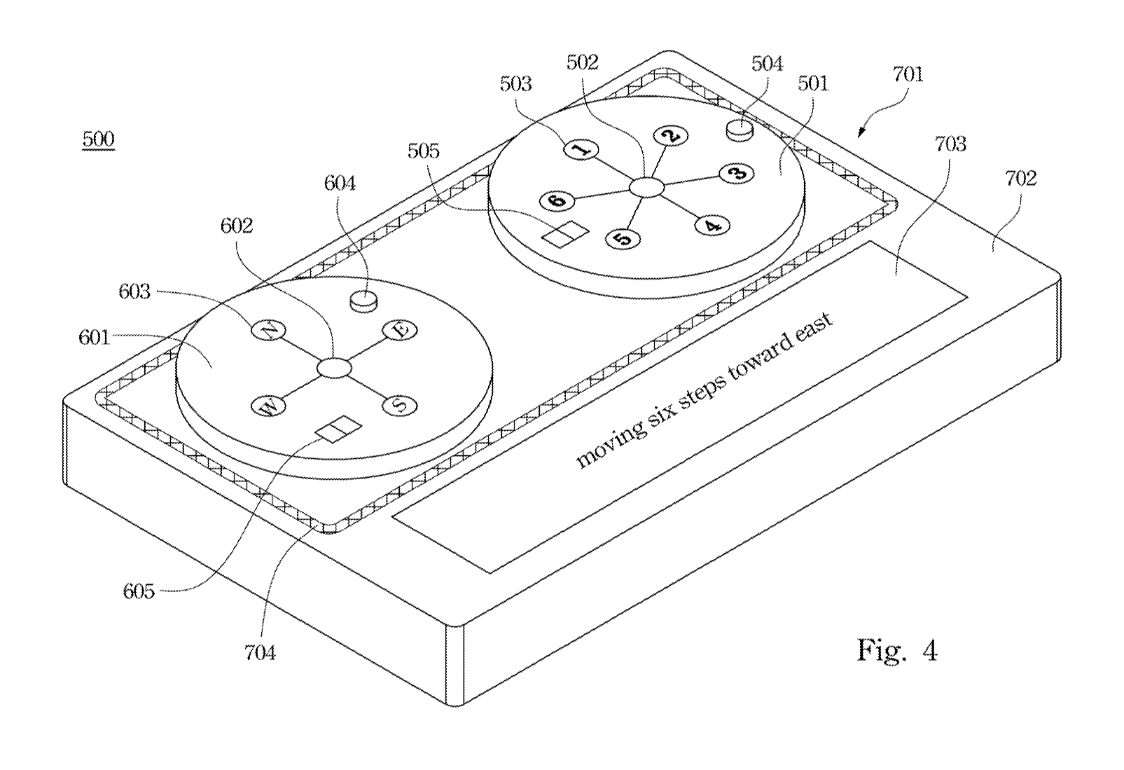

FIG. 4 is a diagram of the data random selection device according to another embodiment of the present invention. The data random selection device 500 includes multiple data generation modules. However, for easy description only two data generation modules 501 and 601 are illustrated in the present embodiment, but it is not limited. The data generation module 501 includes a RFID tag 502, six LED indicator lights 503 (i.e. indication units, numbered from 1 to 6), a reset button 504 and an operation mode configuration is interface 505. The LED indicator lights 503, the reset, button 504 and the operation mode configuration interface 505 are electrically coupled to the RFID tag 502. The data generation module 601 includes a RFID tag 602, four LED indicator lights 603 (i.e. indication units, numbered E, W, S, N), a reset button 604 and an operation mode configuration interface 605. The LED indicator lights 603, the reset button 604 and the operation mode configuration interface 605 are all electrically coupled to the RFID tag 602.

Each of the RFID tags 502, 602 is configured for storing and sending one identification code. Each of the LED indicator lights 503 and each of LED indicator lights 603 corresponds to one indication value. One of the LED indicator lights 503 and one of the LED indicator lights 603 are randomly driven to be lighted up so as to generate an indication signal when the RFID tags 502, 602 send the identification codes.

The data random selection device 500 further includes a data reading module 701. The data reading module 701 includes a wireless radio frequency reader 702, a display screen 703 and an antenna 704, in which the wireless radio frequency reader 702 sends the RF signal through the antenna 704 and the wireless radio frequency reader 702 is electrically coupled to the display screen 703. The wireless radio frequency reader 702 is configured for receiving the identification codes from the RFID tags 502, 602 respectively in the data generation modules 501, 601, and for reading the indication values corresponding to the randomly driven LED indicator lights 503, 603 respectively in the data generation modules 501, 601. The display screen 703 is configured for outputting at least the indication values corresponding to the randomly driven LED indicator lights 503, 603. Under a preset mode in the present embodiment, the data generation module 501 operates with six selection items (1 to 6) which correspond to the LED indicator lights 503 numbered from 1 to 6, respectively, and the data generation module 601 operates with four selection items (east, west, south, north) which correspond to the LED indicator lights 603 denoted as “E”, “W”, “S”, “N”, respectively.

In operation, the wireless radio frequency reader 702 first sends an RF signal. After that, the RFID tag 502 receives the RF signal, and the LED indicator lights 503 numbered from 1 to 6 are randomly lighted up within a predetermined duration. After the predetermined duration, only the LED indicator light 503 corresponding to the selected item is driven to be lighted up, and the rest of the LED indicator lights 503 are turned off. Similarly, after the RFID tag 602 receives the RF signal, and the LED indicator lights 603 denoted as “E”, “W”, “S”, “N” are randomly lighted up within a predetermined duration. After the predetermined duration, only the LED indicator light 603 corresponding to the selected item is driven to be lighted up, and the rest of the LED indicator lights 603 are turned off. For example, if the data generation module 501 generates the indication value corresponding to the selection item “6”, only the LED indicator light 503 numbered “6” is driven to be lighted up in the end. Similarly, if the data generation module 601 generates the indication value corresponding to the selection item “E”, only the LED indicator light 603 denoted as “E” is driven to be lighted up in the end.

On the other hand, the RFID tag 502 stores an identification code, in which the identification code and the indication value corresponding to the selected item in the data generation module 501 are combined to be a group of identification data and then the identification data are sent to the data reading is module 701. Likewise, the RFID tag 602 also stores an identification code, in which the identification code and the indication value corresponding to the selected item in the data generation module 601 are combined to be another group of identification data and then the identification data are sent to the data reading module 701. The wireless radio frequency reader 702 receives the identification data and combines the identification data into an instruction, and then the instruction is displayed on the display screen 703.

For example, the identification code of the RFID tag 502 may represent the direction but not limited thereto, and the identification code of the RFID tag 602 may represent the amount of steps but not limited thereto. As illustrated in FIG. 4, in the RFID tag 502 the selected item is “6” and the identification code represents the amount of steps, which are combined to be the identification data “step-6”. Likewise, in the RFID tag 602 the selected item is “east” and the identification code represents the direction, which are combined to be the identification data “direction-east”. The wireless radio frequency reader 702 receives the identification data and combines the identification data into an instruction “moving six steps forward east”, and then the instruction is displayed on the display screen 703.

Furthermore, the reset buttons 504, 604 are pushed respectively for driving the RFID tags 502, 602 to re-send the identification codes and for triggering the data generation modules 501, 601 to randomly drive one of the LED indicator lights 503 and one of the LED indicator lights 603 again to generate another indication signal. After the reset buttons 504, 604 are pushed, each of the data generation modules 501, 601 sends a group of preset identification data, and the preset identification data are combined to be a group of reset data to replace the data shown on the display screen 703 in a previous round of operation. For example, if the preset reset data in the data generation module 501 include the result “000” and the preset reset data in the data generation module 601 also include the result “000”, which are combined to be the result “000000”, then the result “moving six steps toward east” originally displayed on the screen will be cleared and the result “000000” will be displayed based on the reset operation.

In the meantime of the reset buttons 504, 604 being pushed, the data generation modules 501, 601 start a new round of operation; that is, the LED indicator lights 503, 603 are randomly lighted up within another predetermined duration. After the predetermined duration, only the LED indicator lights 503, 603 corresponding to the new selected items are driven to be lighted up, the indication value corresponding to the new selected item, together with the identification code in the data generation module 501, are combined to be a new group of identification data, and the indication value corresponding to the new selected item, together with the identification code in the data generation module 601, are combined to be another new group of identification data. Each group of identification data is transmitted to the data reading module 701 and displayed on the display screen 203, and the two groups of identification data are combined to be a new instruction displayed on the display screen 703.

For example, the data generation module 501 generates the data corresponding to a new selection item “4” and thus the identification data include the result “step-4” and the data generation module 601 generates the data corresponding to a new selection item “east” and thus the identification data include the result “direction-east”. Thus, after the reset operation, the identification data are combined to be a new instruction “moving four steps toward west” in a new round of operation, in which only the LED indicator light 603 denoted as “W” and the LED indicator light 503 numbered “4” are lighted up.

The operation mode configuration interfaces 505, 605 are configured for setting the amount of selectable items and for selectively deactivating at least one of the LED indicator lights 503 and at least one of the LED indicator lights 603, respectively, such that one of the rest of the LED indicator lights 503 is randomly driven to generate another indication signal and one of the rest of the LED indicator lights 603 is randomly driven to generate yet another indication signal. The operation of the operation mode configuration interfaces 505, 605 is basically the same with that of the operation mode configuration interface 105 shown in FIG. 1. In other words, if the amount of the selectable items is N, the operation mode configuration interfaces 505, 605 are respectively configured for selectively deactivating M of the N LED indicator lights, such that the result is to randomly select one out of the (N−M) items, where N is a positive integer larger than 1, and M is 0 or a positive integer smaller than (N−1).

In practice, the operation mode configuration interfaces 505, 605 may include at least one button or may be integrated into one button for easy manipulation, but not limited thereto. In addition, the data generation module 601 includes four selection items, but it also can be implemented by the data generation module 501 including six selection items only if the amount of the selectable items of the data generation module 501 is set to four by the operation mode configuration interface 505. Therefore, using only one data generation module can accordingly show multiple results.

The data generation modules 501, 601 can be active or passive; that is the RFID tags in the data generation modules 501, 601 can be active or passive. The disposition and operation of internal circuits in the passive data generation module are basically similar to the embodiment shown in FIG. 2. The disposition and operation of internal circuits in the active data generation module are basically similar to the embodiment shown in FIG. 3. Thus, details are not repeated again.

For the foregoing embodiments of the present disclosure, the present disclosure can be applied such that using only one data generation module can imitate multiple modes of data random selection, such as one-out-of-six mode, one-out-of-four mode, one-out-of-two mode, etc. On the other hand, using multiple data generation modules to perform data random selection can realize complex instructions, such that flexibility and interest of the gambling games or board games can thus be increased. Furthermore, the data random selection in the present disclosure is portable and occupies less space due to its small volume.

As is understood by a person skilled in the art, the foregoing embodiments of the present invention are illustrative of the present invention rather than limiting of the present invention. It is intended to cover various modifications and similar arrangements included within the spirit and scope of the appended claims, the scope of which should be accorded with the broadest interpretation so as to encompass all such modifications and similar structures.

What is claimed is:

1. A data random selection device comprising:
a data generation module comprising:
a radio frequency identification (RFID) tag for storing and sending an identification code; and
a plurality of indication units electrically coupled to the RFID tag and separately corresponding to indication values, one of the indication units being randomly driven to generate an indication signal when the RFID tag sending the identification code; and
a data reading module disposed with respect to the data generation module, the data reading module comprising:
a wireless radio frequency reader for receiving the identification code and reading the indication value corresponding to the randomly driven indication unit; and
an output unit electrically coupled to the wireless radio frequency reader, for outputting at least the indication value corresponding to the randomly driven indication unit.

2. The data random selection device as claimed in claim 1, wherein the data generation module further comprises:
an operation mode configuration unit for selectively deactivating at least one of the indication units, such that one of the rest of the indication units is randomly driven to generate another indication signal.

3. The data random selection device as claimed in claim 1, wherein the data generation module further comprises:
a random control unit electrically coupled to the indication units, for randomly driving one of the indication units.

4. The data random selection device as claimed in claim 3, wherein the data generation module further comprises:
a reset unit electrically coupled to the RFID tag; for driving the RFID tag to re-send the identification code and triggering the random control unit to randomly drive one of the indication units again to generate another indication signal.

5. The data random selection device as claimed in claim 1, wherein the output unit is a display screen, a speaker or the combination thereof, and the indication units comprise a plurality of indicator lights.

6. A data random selection device comprising:
a plurality of data generation modules, each of the data generation modules comprising:
a radio frequency identification (RFID) tag for storing and sending an identification code; and
a plurality of indication units electrically coupled to the RFID tag and separately corresponding to indication values, one of the indication units being randomly driven to generate an indication signal when the RFID tag sending the identification code; and
a data reading module disposed with respect to the data generation modules, the data reading module comprising:
a wireless radio frequency reader for receiving the identification codes sent by the RFID tags in the data generation modules and reading the indication values corresponding to the randomly driven indication units in the data generation modules; and
an output unit electrically coupled to the wireless radio frequency reader, for outputting at least the indication values corresponding to the randomly driven indication units in the data generation modules.

7. The data random selection device as claimed in claim 6, wherein in each of the data generation modules the identification code and the indication value corresponding to the randomly driven indication unit are combined to be a group of identification data, the identification data from the data generation modules are combined to be an operation command, and the output unit outputs the operation command.

8. The data random selection device as claimed in claim 6, wherein each of the data generation modules further comprises:
an operation mode configuration unit for selectively deactivating at least one of the indication units, such that one of the rest of the indication units is randomly driven to generate another indication signal.

9. The data random selection device as claimed in claim 6, wherein each of the data generation modules further comprises:
a random control unit electrically coupled to the indication units, for randomly driving one of the indication units.

10. The data random selection device as claimed in claim 9, wherein each of the data generation modules, further comprises:
a reset unit electrically coupled to the RFID tag, for driving the RFID tag to re-send the identification code and triggering the random control unit to randomly drive one of the indication units again to generate another indication signal.

11. The data random selection device as claimed in claim 6, wherein the output unit is a display screen, a speaker or the combination thereof, and the indication units comprise a plurality of indicator lights.
